(19) United States
(12) Patent Application Publication
(10) Pub. No.: US 2003/0145183 A1
(43) Pub. Date: Jul. 31, 2003

(54) Applications for removable storage

(76) Inventor: Phillip T. Muehring, Riverdalc, UT (US)

Correspondence Address: Dan Swayze, Texas Instruments Incorporated, M/S 3999, P.O. Box 655474, Dallas, TX, 75265, US

(21) Appl. No.: 10/354,733

(22) Filed: Jan. 30, 2003

Related U.S. Application Data
(60) Provisional application No. 60/353,940, filed on Jan. 31, 2002.

(51) Int. Cl. G06F 12/14

(52) U.S. Cl. 711/163; 711/112

(57) ABSTRACT

The present invention provides for selectively securing data to a removable storage medium (15). A convey device (11) having an identifier and operable to read an identifier from the removable storage medium (15) and further operable to encrypt the data and write the encrypted data and a passkey to the removable storage medium (15). The passkey includes the convey device identifier, removable storage medium identifier, and a content code which corresponds to the data. An access device (17) having in input adapted to receive the removable storage medium (15) and operable to read the removable storage medium identifier and passkey. The access device (17) is further operable to decrypt the encrypted data in response to an encryption code. The encryption code can be received from a server (13) in which the server has and input (19) adapted to communicate with the convey device (11) and the access device (17) and is operable to correlate the convey device identifier, removable storage medium identifier, and the content code. The server (13) is further operable to issue the encryption code to the access device (17).

This application claims the priority under 35 U.S.C. 119 (e)(1) of copending U.S. provisional application No. 60/353,940, filed on Jan. 31, 2002 and incorporated herein by reference.

### BACKGROUND OF THE INVENTION

1. Technical Field of the Invention

The present invention relates generally to data transfer and, more specifically, to secure data transfer to a removable storage medium.

2. Description of the Related Art

The world is ever changing with technological advancements designed to improve the quality and efficiency of the way we live. As each era of advancements tends to have a theme, the current age could best be described as the Digital Revolution. Today, each aspect of daily routines seems to be converging into the digital domain. Whether work, entertainment or basic life tasks, everything is slowly being turned into bits and bytes. This transformation has put huge demands on being able to store and transport this information.

Solid-state memory in the form of flash memory, for example, has recently become the storage of choice in a variety of mobile and handheld devices, notably information equipment and consumer electronics products. Unlike RAM which is also solid-state memory, flash memory is non-volatile which retains its stored data even after power is turned off. In spite of the high cost, flash memory is increasingly being used in mass storage applications where information is stored semi-permanently in file format. Conventional mass storage, based on rotating magnetic media such as hard drives and floppy disks, is unsuitable for the mobile and handheld environments because disk drives tend to be bulky, are prone to mechanical failure and have high power requirements. These undesirable attributes make disk based storage impractical in most mobile and portable applications.

While a variety of removable mediums exist today for storing video and audio data, such as removable rigid magnetic drives, removable flexible magnetic drives, CD RW, DVD-R, −RW, +RW, RAM, ROM, Flash of all kinds, Magneto Optical, HDD, and Magnetic Tape of all kinds, each may have different encryption for the data stored and generally all stored data is encrypted.

For example, the DVD forum utilizes a special encryption key that is required to decrypt the data, however, this key is in the form of logic gates that are embedded into the end device doing the decryption. Further, this type of security scheme does not enable selective security based on the kind of disc used or that enables the tracking of which write drive wrote the data to the storage medium based on embedded security information.

Though encryption techniques are known to provide some measure of security for removable storage devices, current methods have failed to provide a means for adequate security of protected material (e.g. copyrighted movies and music) while enabling the end user to use the same storage device for unsecure/unencrypted information (example: purchased movies verse home movies) without jeopardizing the secure data. In this arena, an improved approach will add security and provide flexibility for the end user.

Therefore, it would be advantageous to provide improved security for downloading of data (e.g. video, music and etc.) to a removable storage medium in a secure way while providing the flexibility of using the same storage device for unsecure data.

### SUMMARY OF THE INVENTION

The present invention achieves technical advantages a method, apparatus and system for selectively securing data to a removable storage medium. A convey device having an identifier and operable to read an identifier from the removable storage medium and further operable to encrypt the data and write the encrypted data and a passkey to the removable storage medium. The passkey includes the convey device identifier, removable storage medium identifier, and a content code which corresponds to the data. An access device having in input adapted to receive the removable storage medium and operable to read the removable storage medium identifier and passkey. The access device is further operable to decrypt the encrypted data in response to an encryption code. The encryption code can be received from a server in which the server has and input adapted to communicate with the convey device and the access device and is operable to correlate the convey device identifier, removable storage medium identifier, and the content code. The server is further operable to issue the encryption code to the access device.

### BRIEF DESCRIPTION OF THE DRAWINGS

For a more complete understanding of the present invention, reference is made to the following detailed description taken in conjunction with the accompanying drawings wherein:

FIG. 1 illustrates a secure system for data storage in accordance with an exemplary embodiment of the present invention;

FIG. 2 illustrates a download station in accordance with an exemplary embodiment of the present invention; and

FIG. 3 illustrates a playstation in accordance with an exemplary embodiment of the present invention.

### DETAILED DESCRIPTION OF THE INVENTION

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others.

Throughout the drawings, it is noted that the same reference numerals or letters will be used to designate like or equivalent elements having the same function. A detailed description of known functions and constructions unnecessarily obscuring the subject matter of the present invention have been omitted for clarity.

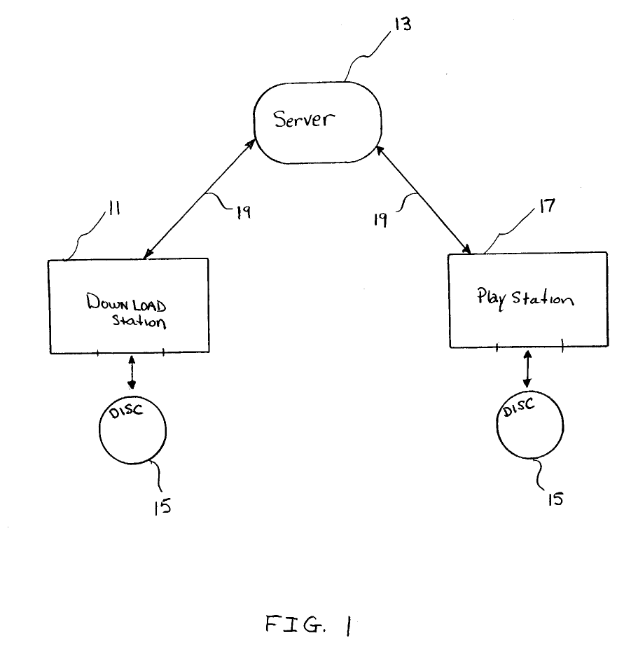

Referring now to FIG. 1 there is illustrated a secure system for data storage in accordance with an exemplary embodiment of the present invention. The system includes a download station 11 adapted to encrypt data, decrypt data, generate passkeys, communicate with other devices, and transfer data to a removable storage device, such as a disc 15. The transferred data can be video and audio such as that found in movies and music, video games, or other programmed data, for example. Each disc 15 is adapted to include an unique identification number (ID) which is stored and encrypted on the disc 15. The ID is also stored in a remote storage device, such as a server 13 which is adapted to be accessed through a telephone connection 19 or some form of net connection. The disc 15 is insertable into the download station 11 where the disc 15 ID is verified by the download station 11 through communication with the server 13. The download station 11 also communicates with the server 13 to notify it of data selected to be programmed to the disc 15 in which the server 13 correlates this data with the download station ID. The download station 11 can also verify the type of disc (i.e. movie disc, audio disc, multi-storage disc, etc.). After the disc 15 is verified, the download station 11 encrypts the selected data and transfers it to the disc 15 along with a passkey generated by the download station 11. The passkey is a combination of a unique ID assigned to the download station, the disc's ID, and a password for correlating to the transferred data.

For access to the transferred data, the disc 15 is introduced to a playstation 17. The playstation 17 is adapted to decrypt the passkey to determine the ID of the download station, the ID of the disc containing the data, and the password. The playstation 17 is further adapted to compare the disc ID determined from the passkey and the ID encrypted on the disc itself (to protect against a pirated disc). The playstation 17 is further adapted to communicate with the server 13 to verify that the download station 11 is valid and did indeed program the disc 15 with the selected data identified by the password. Communication can be through a telephone connection 19 or some form of net connection. With verification complete, the playstation then authorized access to the identified data. Additionally, unsecure or un-encrypted data can be downloaded to the disc 15 for access by the playstation without the need for verification with a download station ID, disc ID or a passkey.

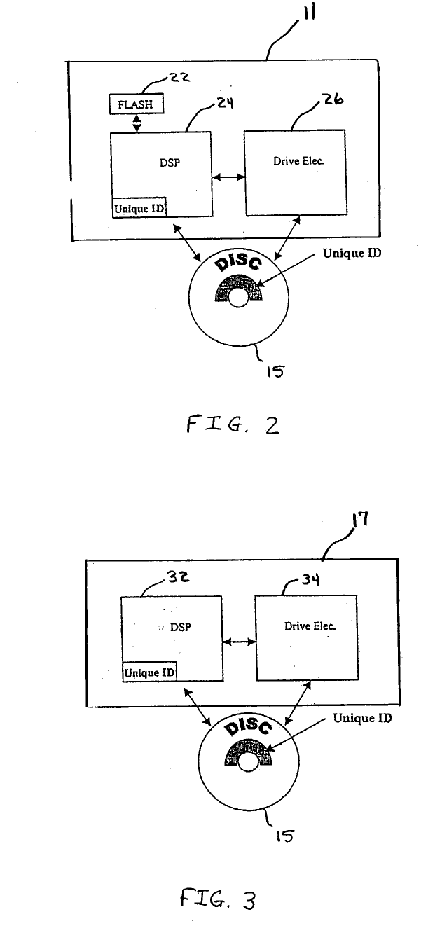

Referring now to FIG. 2 there is illustrated a download station 11 in accordance with an exemplary embodiment of the present invention. The download station 11 includes a digital signal processor (DSP) 24 with a unique ID, memory 22 and drive electronics 26. The DSP ID is a unique 64 bit ID. The DSP 24 is adapted to collect the encrypted disc ID and decrypt it. The DSP is also adapted to connect with the server 13 to compare the disc ID to a list of known manufactured disc IDs stored on the server 13 to verify a valid disc (i.e. not a pirated copy). Further, the DSP is adapted to determine the type of disc (i.e. Movie disc, Audio disc, standard disc, etc.). Data to be transferred to the disc 15 is stored in the download station memory 22. In this embodiment, the memory 22 is flash memory. In addition, the memory 22 can be included within the download station 11 or located remotely to the download station 11. For transfer of data to the disc 15, the DSP 24 collects the data from the memory 22, encrypts the data, generates a passkey for the data (via the passkey generator 28), and notifies the drive electronics 26 to transfer the encrypted data and passkey to the disc 15 in which the drive electronics 26 is adapted to transfer the data. The passkey is a combination of the DSP ID, the disc ID and a password for access to the data.

In another embodiment, the DSP 24 collects the data to be transferred from a remote storage device. For example, the DSP 24 can collect the data over the telephone connection 19 from memory associated with the server 13.

Referring now to FIG. 3 there is illustrated a playstation 17 in accordance with an exemplary embodiment of the present invention. The playstation 17 includes a DSP 32 and drive electronics 34 for communicating with the disc 15. The drive electronics 34 is adapted to read from the disc 15 to obtain the passkey and the disc ID. The DSP 32 is adapted to collect and decrypt the passkey to reveal the DSP ID of the programming download station 11, the disc ID of the disc that was programmed by the programming download station 11, and the password for access to the data. The DSP 32 is further adapted to verify that the disc ID of the disc that was programmed by the programming download station 11 matches the disc ID of the disc introduced to the playstation 17. Also, the DSP 32 is adapted to verify, through communication with the server 13, that the download station ID is valid and did indeed program the disc 15 with the data identified by the password. Following a positive verification, the DSP 32 decrypts the data and makes the data available to the drive electronics 34 for user access. The encryption/decryption technique of the DSP 22, 32 can be selectively updated to further frustrate pirating efforts. For example, the encryption technique can be updated once a day for each download station through communications with the server 13.

All 4 forms of media (ROM/WORM/RW/HYBRID) can have uses in embodiments of the present invention. For example in a video application and, more specifically in a movie rental application, a removable storage disc can be purchased at the entrance of a video store which allows for movie downloads. For example, 100 GB of data on a 120 mm disc can hold between 5 and 10 movies depending on the compression and resolution. The download station 11 can enable searching the memory 22 for available video and viewing of short previews. For executing a download, the station 11 bursts a movie to the disc in any format desired (NTSC/HDTV or both). A client then pays for the movie rental and heads home for viewing on a playstation 17 (i.e. digital VCR). After watching the video at home, the playstation 17 can selectively disable the movie either after so many viewings or after so much time has elapsed, for example.

To secure the IP stored on the disc, the following exemplary security implementation can be used:

STEP 1: The download station 11 verifies and identifies the disc 15 (which is encrypted with a unique ID). The download station DSP 24 (which has a unique 64 bit ID) collects the encrypted unique disc ID and decrypts it. The DSP 24 then connects to the server 13 to comparing the disc ID to a list of known manufactured IDs to verify it is a valid disc (i.e. not a pirated copy). The DSP 24 also determines what kind of disc it is (i.e. Movie disc, Audio Disc, Standard Disc or etc).

STEP 2: Authorization is given to write the movie to the disc. The DSP 24 signals the drive electronics 26 that everything is verified with the disc 15 and authorization to copy the movie to the disc 15 is given.

STEP 3: The movie is written to the disc 15. The encrypted information to be written to the disc 15 is sent to the drive 26 to be written to the disc 15. Also written to the disc 15 is a passkey which is made up of a combination of the DSP ID, the disc ID and a password for the movie.

STEP 4: The disc 15 is taken home by the client and inserted into their playstation 17 (i.e. DVCR).

STEP 5: The client enables play to watch the video. The playstation DSP 32 then decrypts the passkey revealing the DSP ID of the station that programmed the movie, the ID of the disc that it was stored on and the password for the movie. If the disc ID from this passkey matches the ID seen on the disc itself (again making sure the disc isn't pirated), then the DSP 32 verifies from the server 13 that the download station 11 is valid and did indeed program this disc with the movie identified by the password. The DSP 32 authorizes the drive electronics 34 to begin reading the movie and decrypts the movie in real time for viewing on a viewing monitor. The encryption/decryption technique on the DSP 32 can be updated as often as necessary via the phone connection. Since this code is relatively small, it would be easy to update with the b/w of the phone line. This would further frustrate pirating efforts.

Should anyone try to pirate the content they would need to decipher the encryption scheme, produce their own disc with a pirated unique identifier, pirate the unique identifier in the DSP, produce their own DSP with the encryption algorithm and repeat this for each encryption algorithm updated. The added verification between the writing download station and the Digital VCR would also frustrate pirating. If someone does however, successfully copy the IP, then of the recorded information on the disc will enable the tracing and prosecuting of the violators.

In at least one embodiment the disc 15 is pre-recorded with the encrypted movie, encryption algorithm for the DSP 24, the passkey and everything required to play on the Digital VCR. Thus, the client's experience is very similar to today.

In another embodiment, the disc 15 is pre-recorded with the encrypted movie only. The movie disc 15 is then inserted into a download station 11 in which the DSP 24 in cooperation with the drive compares the unique ID on the disc 15 to ensure it is a valid disc. The DSP 24 then verifies via the server 13 that the movie on the disc is correct. If it is, then the unique ID of the disc 15 is combined with the unique ID of the DSP 24 and the password for the movie. This passkey is then written to the disc 15 along with the encryption code.

The server 13 then records that this movie is permanently aligned with this particular disc. If anyone else with a disc that has the same unique ID tries to do anything other than play that movie, then it is marked as a pirate copy. The client is then charged for the movie.

Upon placing the disc 15 in the player 17 at home, the DSP 32 verifies that the disc ID is valid and what kind of disc it is. The server 13 indicates that this disc 15 should have a certain movie on it. The DSP 32 decrypts the passkey to verify the disc ID's match, the right DSP ID wrote the passkey, and that the right movie is stored on the disc. If everything matches, then it proceeds to load the encryption code into the DSP 32. After the encryption code is loaded into the DSP 32, it begins to play the movie.

In another embodiment, inventory of movies are eliminated. The download station 11, as in the movie rental example, is implemented instead. The big difference would be that the client selects off the shelf only the jewell case for the movie. They would take this to the cashier, who would insert a blank disc into the drive and scan the case. Scanning the case enables the drive to follow the standard procedure for writing the movie indicated by the data from the scan. The client would pay for the movie and proceed as normal.

Due to the permanent nature of the desired movie on the disc 15, it is necessary to store the encryption technique on the disc 15 as this is the most convenient way to manage the updates to the encryption technology.

The combination of download station ID (i.e. DSP ID), disc ID and passkey (i.e. content key) provides increased security for storage of data that is also trackable to the very download station that programmed the content. Further, disc categorization enables unencrypted use of the drive technology for non-secure data. Disc categorization is simply identifying either a disc or a layer on a disc as either a movie disc, an audio disc, a data disc, a personal disc, or etc. In this way the system could easily identify a home movie (i.e. a personal disc) verses a store bought movie that could contain intellectual property.

Although a preferred embodiment of the method and system of the present invention has been illustrated in the accompanied drawings and described in the foregoing Detailed Description, it is understood that the invention is not limited to the embodiments disclosed, but is capable of numerous rearrangements, modifications, and substitutions without departing from the spirit of the invention as set forth and defined by the following claims.

What is claimed is:

1. A system for selectively securing data to a removable storage medium, comprising:
a convey device having an identifier and operable to read an identifier from said removable storage medium, said convey device further operable to encrypt said data and write said encrypted data and a passkey to said removable storage medium, wherein said passkey includes said convey device identifier, said removable storage medium identifier and a content code which corresponds to said data;
an access device having in input adapted to receive said removable storage medium and operable to read said removable storage medium identifier and said passkey, said access device further operable to decrypt said encrypted data following receipt of an encryption code; and
a server having and input adapted to communicate with said convey device and said access device and operable to correlate said convey device identifier, said removable storage medium identifier and said content code, said server further operable to issue said encryption code to said access device.

2. The system of claim 1, wherein said access device is further operable to verify said removable storage medium identifier with that included in said passkey.

3 The system of claim 2, wherein said access device is further operable to request said encryption code from said server upon verifying said removable storage medium identifier, and wherein said server issues said encryption code upon verifying said convey device identifier, said removable storage medium identifier and said content code.

4. The system of claim 1, wherein said convey device and said server is further cooperable to verify of said removable storage medium prior to transfer of said encrypted data.

5. The system of claim 1, wherein a user selects to have said data secured by said encryption and said passkey.

6. The system of claim 1, wherein said convey device comprises;
a processor having a unique identifier and adapted to encrypt said data and generate said passkey;
a memory coupled to said processor and adapted to store said data prior to encryption; and
a drive circuit adapted to read and write to said removable storage medium.

7. The system of claim 6, wherein said processor is further adapted to authorize said drive circuit to write said encrypt data to said removable storage medium.

8. A method for selective security of data transfer from a transfer device to a removable storage medium, comprising:
for data transfer to said removable storage medium:
correlating data to an identifier associated with said transfer device and said removable storage medium with a content code;
encrypting said data, wherein said transfer device encrypts said data and writes said encrypted data to said removable storage medium; and
generating a passkey for inclusion with said encrypted data, wherein said passkey includes said content code, said transfer device identifier and said removable storage medium identifier; and
for data access from said removable storage medium:
requesting an encryption code from said server for decrypting said encrypted data, wherein said request includes said passkey;
verifying that said encrypted data which was written by said transfer device to said removable storage medium, wherein said data, transfer device and removable storage medium are identified respectively by said content code, transfer device identifier and removable storage medium identifier of said passkey; and
issuing said encryption code for decrypting of said encrypted data upon said verification.

9 The method of claim 8 further comprising verifying said removable storage medium identifier with a server prior to writing said encrypted data to said removable storage medium, wherein a list of valid removable storage medium identifiers are stored in a central location associated with said server.

10. The method of claim 8 further comprising verifying said removable storage medium prior to said requesting an encryption code, wherein an identifier on said removable storage medium is compared to an identifier included with said passkey.

11. The method of claim 8 further comprising selecting said data from a plurality of data stored in a memory associated with said transfer device.

12. The method of claim 8, wherein said transfer device comprises;
a processor having a unique identifier and adapted to encrypt said data and generate said passkey; wherein said memory is coupled to said processor; and
a drive circuit adapted to read and write to said removable storage medium as instructed from said processor.

13. The method of claim 8, wherein said correlation results are stored in a server and said data is accessed from an access device operable to request said encryption code from said server.

14. The method of claim 13, wherein said server issues said encryption code upon verifying said transfer device identifier, said removable storage medium identifier and said content code.

15. An apparatus for selectively securing data to a removable storage medium, comprising:
a drive circuit adapted to read and write to said removable storage medium;
a processor coupled to said drive circuit and adapted to determine an identifier associated with said removable storage medium, said processor further having an input for coupling to a server for verifying said removable storage medium identifier; and
a memory coupled to said processor and adapted to store said data, wherein said processor is further adapted to encrypt said stored data and instruct said drive circuit to write said encrypted data to said removable storage medium; and wherein
said processor is further adapted to generate a passkey comprising said removable storage medium identifier, a content code associated with said data, and an identifier associated with said processor, wherein said processor further instructs said drive circuit to write said passkey to said removable storage medium.

16. The apparatus of claim 15, wherein said processor is further adapted to receive an encryption code from said server for encrypting said data.

17. The apparatus of claim 16, wherein said processor is further adapted to encrypt data written to said removable storage medium responsive to said encryption code.

18. The apparatus of claim 15, wherein said processor is cooperable with said server for correlating said data, processor identifier and removable storage medium identifier for verification by a remote device.

19. The apparatus of claim 15, wherein said memory is a remote storage device.

20. The apparatus of claim 15, wherein said removable storage medium is disk.
